(19) United States
(12) Patent Application Publication
(10) Pub. No.: US 2002/0184270 A1
(43) Pub. Date: Dec. 5, 2002

(54) Relating to data delivery

(76) Inventor: Roger Brian Gimson, Redland (GB)

Correspondence Address: HEWLETT-PACKARD COMPANY, Intellectual Property Administration, P.O. Box 272400, Fort Collin, CO, 80527-2400, US

(21) Appl. No.: 10/106,692

(22) Filed: Mar. 26, 2002

(30) Foreign Application Priority Data
Mar. 28, 2001 (GB) 0107772.6

(51) Int. Cl. G06F 17/24

(52) U.S. Cl. 707/529; 707/534

(57) ABSTRACT

A method of sending data comprising one or more character strings held on a primary processing apparatus 2, to one or more data-receiving devices 26, 28, 30 on receipt by said primary processing apparatus 2 of a request for data, said method comprising causing a processing circuitry to process the data and perform one or more of the following: accessing a database of replacement data or replacement data rules and replace one or more character strings with replacement data selected from the database or determined by the replacement data rules; ii. altering font characteristics in order to tailor the displayed character strings to be correctly displayed; and iii. deleting portions of the document. The method can be used to help ensure that data can be correctly displayed on a variety of data receiving devices 26, 28, 30 each of which can have different display characteristics.

This invention relates to an improved method and apparatus for providing data, especially, but not exclusively, to devices remote from a processing apparatus, such as a computer.

Many documents are now produced using computers. Such documents may be intended for printed publications, such as newspapers, magazines, books, etc. or for electronic publication, such as for e-mails, pages to be displayed on the World Wide Web, etc.

Page description languages are well known to achieve such computer-based preparation. These description languages provide instructions for a page renderer so that the final page can be produced from the given instructions. Therefore, the instructions provided to the renderer contain not only the content of the document, but also information about how the content should be arranged on the page (whether paper, or computer screen). Well known page description languages include LATEX, POSTSCRIPT, HTML.

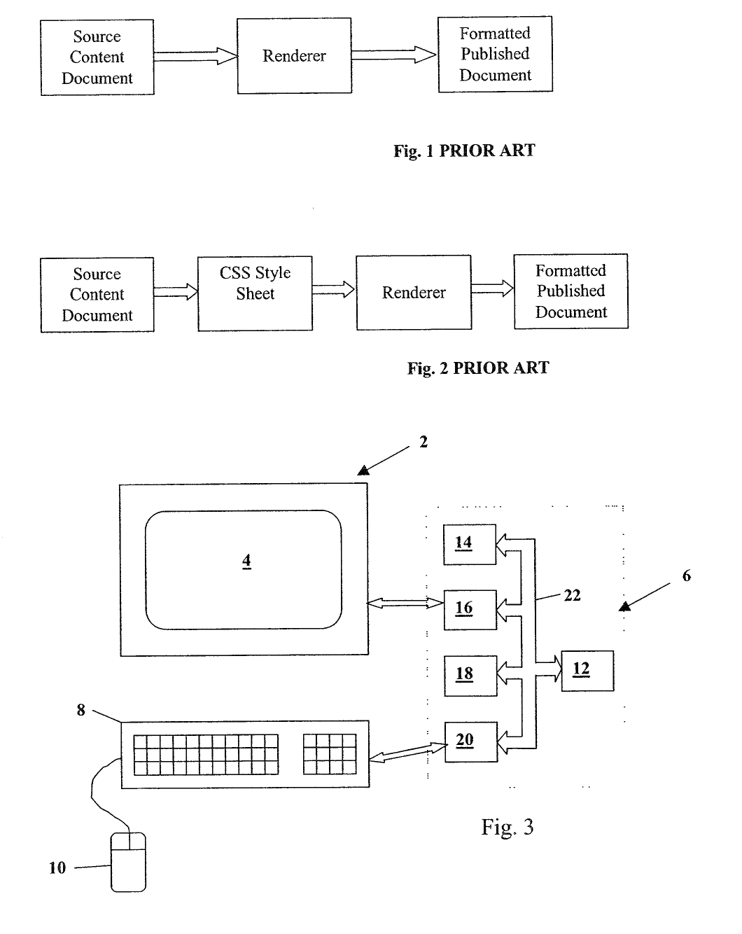

When using such description languages, a renderer, as shown in FIG. 1, produces the appearance of the final document. The renderer is constrained by the display capabilities of the device on which the document is rendered. A problem with this approach is that the document may appear different on different display media. For example HTML documents can look different when displayed on a screen with portrait rather than landscape display aspect. It may therefore be necessary to produce different versions of a document to achieve an acceptable appearance on each of many different display media.

The previously discussed problems can be increased when content description languages such as XML (extensible mark up language) are used to specify the content to be displayed. Unlike the traditional description languages described hereinbefore, XML does not necessarily contain information relating to the layout of the published document, but may simply define the information held within the content document. The person skilled in the art will readily understand this.

In certain situations an XML content document must be interpreted by an intermediate level before being passed to the renderer, as shown in FIG. 2. One such example of the intermediate level is an XSL style sheet which may define the conversion of an XML content document into HTML for rendering. The use of such an intermediate level increases the complexity of creating a number of pages specifically designed for each display medium.

This problem is further increased by the current diversification of devices, and hence display mediums, upon which electronically published documents may be displayed. For example pages of the World Wide Web (or simply web) can now be accessed by devices such as WAP (Wireless Application Protocol) telephones, web enabled TV's, and Personal Digital Assistants (PDA's) (landscape, and portrait versions), printers, ebooks, etc.

Such diversification can lead to an increased workload for publishers in ensuring that the content they are producing is suitable for display on a wide range of devices. Therefore, there is an ongoing need to try and simplify the process for publishing content on a number of different devices.

A particular problem when adapting documents, especially for small devices, is that of fitting a piece of text within a limited display area. For example, on some displays, such as television screens, it is inconvenient to scroll text. In this case, just sufficient text must be included in a document (or web page) to fit on one screen. On other devices, such as WAP telephones, the width of the display limits the length of words that can be used for page elements such as titles or menu selection labels. Undesirable truncation may result if the text is too long.

It is an object of this invention to try and contribute to ameliorating the problems discussed hereinbefore.

According to a first aspect of the invention there is provided a method of sending data held on a primary processing apparatus, to one or more data-receiving devices on receipt by said primary processing apparatus of a request for data, said method comprising causing a processing circuitry to compare said data with one or more parameters and process said data such that it meets the known parameters and including the step of sending the data to the data-receiving device.

An advantage of such a method is that it allows the data to be tailored in a desired manner and helps to ensure that data is correctly displayed.

The processing circuitry that compares and processes said data may be situated on the primary processing apparatus. This is perhaps the preferred embodiment since it allows the data to be processed before being sent to the data-receiving device. The processing circuitry of the primary processing apparatus may be more powerful than that provided on the data-receiving device. Further, the transmission of the data may be simplified, and/or speeded up it if it is processed before sending.

Alternatively, or additionally, the processing circuitry that compares and processes said data may be situated on the data-receiving device. Such an arrangement may be advantageous if the processing circuitry of the primary processing apparatus is of limited power.

In yet another alternative, or addition, the processing circuitry may be situated at some intermediate processing node between the primary processing apparatus and the data-receiving device. The processing node may be provided within a network connecting the primary processing apparatus and the data-receiving device. Such an arrangement may, for example, be used on a gateway between the Internet and a mobile telephone network to which the data-receiving device is connected.

The method may comprise causing the processing circuitry to replace portions of the data with replacement data having the same or substantially the same meaning as the replaced portions, but which better fits the whole or a portion of the display of the data-receiving device. Generally, the replacement data and the replaced data will be of different lengths. In one particular embodiment this is advantageous when the data is displayed on a screen. The method may comprise replacing portions with replacement data that is shorter than the replaced portions. Often the display space is limited, so that the advantage of the replacement is that the replacement data will fit the display space when the original data would not. A further advantage, in the case that the amount of data is reduced, is that the data may take less time to be sent to the data-receiving device.

Alternatively, or additionally, the processing circuitry may replace data with replacement data that is longer than the replaced portions. This is advantageous in embodiments in which the data is displayed on a screen. For example it may be more aesthetically pleasing if the data completely fills the screen rather than partially filling the screen.

The replacement data may comprise a synonym of the replaced data, or alternatively, the replacement data may comprise an abbreviation of the replaced data. Each of these techniques is advantageous since it allows the data to be reduced in length without altering, or substantially altering the meaning of the data. It may alternatively, or additionally, comprise an alternative for partial or complete phrases of replaced data. For example, a shorter sentence may be used to replace a long sentence of the same meaning.

A database may be maintained of a list of synonyms and/or abbreviations for one or more data items. It may also include alternatives, such as short phrases or sentences to replace longer phrases or sentences of replaced data. In general, any piece of text in a document that is found to have a match in the database will be replaced by an equivalent (usually shorter) replacement data. Database is intended to cover any collection of information stored in a searchable manner. Alternatively a set of replacement rules may be provided (which rules could be stored in a database). Providing such a database is advantageous since it provides a convenient source to obtain replacement data to replace portions of the original data.

The data held on the primary processing apparatus may have predetermined characteristics such that when it is displayed it appears in a predetermined manner. The method may comprise causing the processing circuitry to use the predetermined characteristics of the data to determine whether it fits into a predetermined portion of a display on which it is to be displayed and in the event that it will not fit the processing circuitry may replace the data as described previously or alter its predetermined characteristics until it does fit. This is advantageous because it allows the data to be displayed appropriately.

The data may comprise one or more strings of characters, which may or may not be words.

Conveniently, the predetermined characteristics may comprise any one or more of the following: the typeface in which the characters are to be displayed; the point size that in which the characters are to be displayed; whether the characters are displayed in upper or lower case; the spacing between characters; whether the characters are displayed in bold; whether the characters are displayed in italics; or any other characteristic of the characters that effects the dimension of characters, or strings of characters, when they are displayed on a display.

The processing may comprise deleting portions of the data that are redundant. For example, if the data is text then it may be possible to delete words such as “the”, and similar words, without affecting the meaning of the text.

In some embodiments, the method comprises iteratively performing the method, which may comprise performing a first level of processing, assessing whether this first level allows the data to meet the known parameters, and if not performing further levels of processing until the data meets the known parameters. This stepwise manner of performing the method is advantageous since it allows the data to be processed (and consequently altered) as little as possible.

The method may comprise processing the data in a first manner and if this processing is unsuccessful, undoing the processing that has occurred and performing a second manner of processing. This process may continue until the data meets the known parameters. Such a method is advantageous because some forms of processing are more severe than others. The first manner of processing may process the data to a first level and the second manner may process to a second level higher than the first. Therefore, processing the data in the first manner, undoing this processing and performing the second manner will still result in a higher level of processing than simply applying the first manner of processing. However, applying the first manner of processing and then applying the second manner would result in a much higher level of processing which may be too high and result in a degradation of the quality of the data.

The method may not actually apply the processing to the data, but may instead assess the effect on the data should that processing be applied. For example, if the data is text then one strategy for processing it is to change the font. In such an example, the method may not actually change the font of the text, but would instead calculate the effect on the data should such a process be applied to the data. Such a method is advantageous because it is likely to be quicker and less computationally intensive that actually applying the processing to the data and then undoing the changes.

Alternatively, the method may simply apply a first manner of processing and follow this with further levels of processing without undoing earlier levels.

Preferably, the data-receiving devices display data that they are sent by the primary processing apparatus. An advantage of the method applied to displaying the data-receiving devices is that allows the data to be displayed correctly.

Preferably, the method comprises sending data between the primary processing apparatus and the data-receiving device via a network connection. An advantage of this is that it is possible for the two devices to be separated by great distances.

The method may use any one or more of the following network connections: a Local Area Network (LAN), a Wide Area Network, World Wide Web (including that used by WAP telephones), other internet connections (FTP, gopher, etc.), temporary connections (such as Bluetooth, IRDA, etc.), Ethernet connections, etc.

The method may comprise determining the identity of the data-receiving device that has requested data, before data is sent from the primary processing apparatus.

Conveniently, the method may comprise causing the data-receiving device to send its identity to the primary processing apparatus. Such a method is advantageous because it allows the primary processing apparatus to determine the known parameters. For example the identity of the data-receiving device may be contained in the header information of the request, which may be as defined in the W3C (World Wide Web consortium) proposed Composite Capabilities/Preferences Profile (CC/PP). In alternative embodiments it may be possible to rely on an interaction protocol such as the HP JETSEND INTERACTION PROTOCOL (JIP) as described in EP 0 872 991 to allow negotiation between devices for effective content delivery. This, too, allows devices of a different nature to communicate.

Alternatively, or additionally, the method may comprise causing the data-reeiving device to send the parameters of its display to the primary processing apparatus. Again such a method is advantageous because it allows the primary processing apparatus to determine the known parameters.

In yet a further embodiment the primary processing apparatus may simply send the data to the data-receiving device without processing the data and only perform processing if it receives an error code in return from the data-receiving device. The error code may be a text overflow message or the like. If an error code is received, the primary processing apparatus may then perform a first level of processing, and retransmit the data. These steps of transmission, and processing of the data on the receipt of an error code are continued until the data is processed to its maximum, or no error code is received.

According to a second aspect of the invention there is provided a method of editing a document such that it can be correctly displayed, the document comprising one or more character strings, the method comprising causing a processing circuitry to process the document and perform one or more of the following:

i. accessing a database of replacement data or replacement data rules and replacing one or more character strings with replacement data selected from the database or determined by the replacement data rules;

ii. altering font characteristics in order to tailor the displayed character strings to be correctly displayed.

iii. deleting portions of the document.

The altering of the font characteristics may include altering the point size of the characters. Alternatively or additionally, the type face may be altered.

The replacement data may comprise synonyms and/or abbreviations, and/or short pieces of text which replace longer pieces of text in the document.

According to a third aspect of the invention there is provided a computer readable medium holding a program arranged to run the method of the first or second aspects of the invention.

A computer readable medium may comprise any one of the following: a floppy disk, a CDROM, a DVD ROM/RAM, a ZIP disk, LS120 disk, any other suitable physical format, a transmitted signal, an internet download, etc.

According to a fourth aspect of the invention there is provided a primary processing apparatus arranged to hold data and comprising processing circuitry including a transmitter and a receiver, the receiver arranged to receive a data request and pass said request to the processing circuitry, on receipt of said data request said processing circuitry being arranged to process said data in accordance with the method of the second aspect of the invention, and said transmitter being arranged to transmit said processed data.

The primary processing apparatus may be a server, or any other type of computer, such as a PC, an APPLE, etc. Alternatively, the primary processing apparatus may be any other form of computing device such as a WAP telephone, a PDA, an ebook, a web enabled television, etc.

According to a fifth aspect of the invention there is provided a data-receiving device that is controlled by a program, wherein the software is tailored to facilitate communication with the apparatus of the fourth aspect of the invention.

The apparatus of the fourth aspect of the invention is likely to be able to communicate with a data-receiving device, which is running unmodified software. However, modifying the software that runs on the data receiving device may allow the data-receiving device to better communicate with the apparatus and as such be advantageous.

The data-receiving apparatus may be any one or more of the following: a WAP telephone, a web enabled tv, a PC, a PDA, ebook, a printer, or any other suitable access device.

The data-receiving device may be arranged to communicate its identity to the primary processing apparatus. An advantage of this feature is that it allows the primary processing apparatus to determine the known parameters.

Alternatively, or additionally, the data-receiving device may be arranged to communicate to the primary processing device the characteristics of its display. This is also, advantageous because it allows the primary processing apparatus to determine the known parameters.

There now follows by way of example a detailed description of the present invention with reference to the accompanying drawings of which:

FIGS. 1 and 2 show prior art solutions for sending data to a data-receiving device;

FIG. 3 schematically shows a the architecture of a computer capable of acting as a server for this invention;

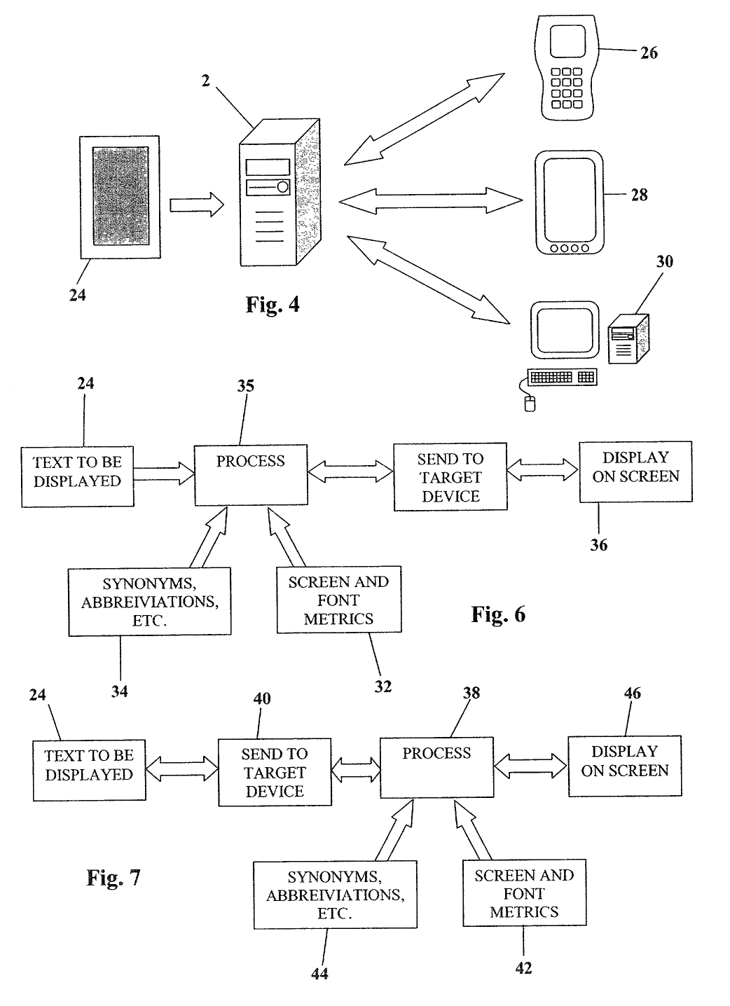

FIG. 4 schematically shows how a single page can be published on to a number of different devices;

FIG. 5 shows an example of compression that can be achieved; and

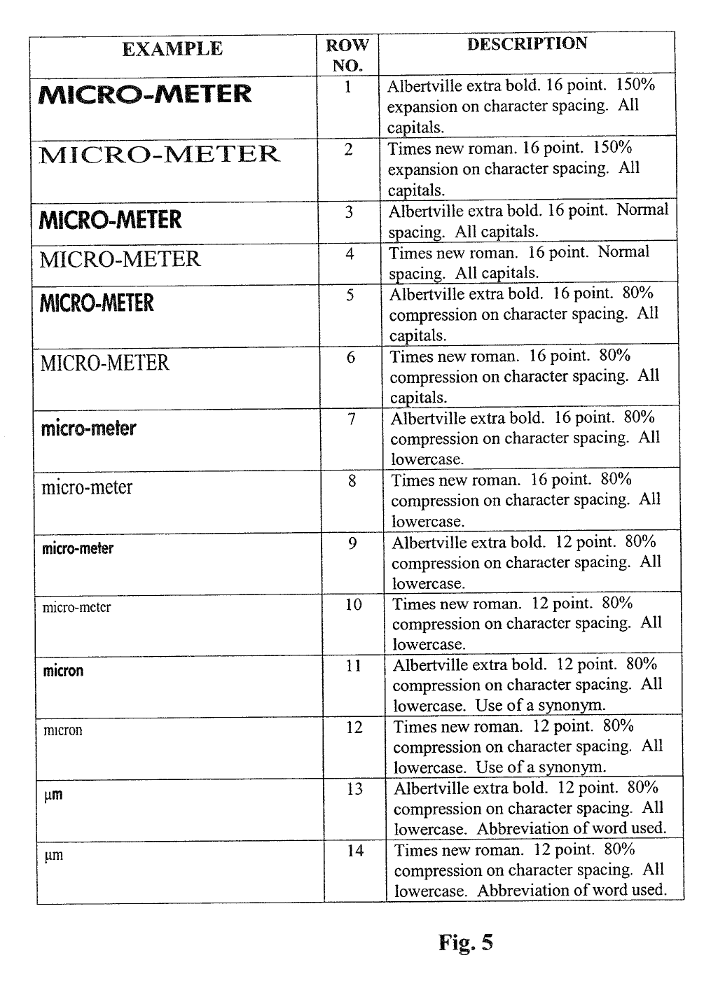

FIG. 6 and 7 show schematics of two different embodiments of how the invention can be used to transmit data to a data-receiving device.

This particular invention is applicable to distribute data electronically, and in particular via the World Wide Web, or in short the web. Such technology is well known. Generally the data to be distributed is held on a primary processing apparatus, or server 2, as shown in FIG. 3, and can be requested by any number of devices that are capable of communicating with the server 2.

In this embodiment the server 2 comprises a display 4, processing circuitry 6, a keyboard 8, and mouse 10. The processing circuitry 6 further comprises a processing unit 12, a hard drive 14, a video driver 16, memory 18 (RAM and ROM) and an I/O subsystem 20 which all communicate with one another, as is known in the art, via a system bus 22. The processing unit 12 comprises an INTEL PENTIUM series processor, running at typically between 700 MHz and 1.2 GHz.

As is known in the art the ROM portion of the memory 18 contains the Basic Input Output System (BIOS) that controls basic hardware functionality. The RAM portion of memory 18 is a volatile memory used to hold instructions that are being executed, such as program code, etc. The hard drive 14 is used as mass storage for programs and other data.

Other devices such as CDROMS, DVD ROMS, network cards, etc. could be coupled to the system bus 22 and allow for storage of data, communication with other computers over a network, etc.

The server 2 could have the architecture known as a PC, originally based on the IBM specification, but could equally have other architectures. The server could may be an APPLE, or be a RISC system, and may run a variety of operating systems (perhaps HP-UX, LINUX, UNIX, MICROSOFT NT, AIX™, or the like).

In this embodiment, data, in this case a document 24, is input to the server 2, which stores the data and distributes it on request to a data-receiving device. The requesting device can be any device that is capable of communicating with the server 2. When the server 2 receives a request from a device it will forward the requested data onto this or another data-receiving device.

Under web protocols the server 2 is given a unique address, which is commonly referred to as a URL, or “Uniform Resource Locator”. The URL generally takes the format http://hostname/. . . where “hostname” is the address of the server. According to known protocols this URL is mapped into an address, generally through use of a nameserver.

A common Internet protocol that governs the transmission of data across the web is HTTP (Hypertext Transfer Protocol). This ensures that a URL entered is correctly translated in to a server address and subsequently governs how, and what data is sent across the web. As long as a device can communicate using HTTP it can communicate with the web, and consequently the server 2.

Indeed, FIG. 4 shows a variety of devices that can communicate with the server 2; including a WAP (Wireless Application Protocol) telephone 26, a PDA 28 (Personal Digital Assistant), and a PC 30 (or any other suitable computer such as an APPLE, etc.). This list of devices that can request data from the server is not exhaustive. It will be appreciated that the display characteristic of each of the devices mentioned varies substantially.

An example of a WAP enabled telephone is the NOKIA 7110 that has a black and white display of 96×65 pixels, which due to its limited nature is generally used to display textual information. The display is limited to 96 ×44 pixels of body text with the remainder providing titles, buttons, etc. The body text area is therefore limited to approximately 15 characters per line and 4 lines of text. The characters per line value is only an approximate value due to the use of proportional spacing.

In this example the PDA 28 is an HP Jornada 690 that operates using the Microsoft Windows CE operating system, and runs Microsoft Pocket Explorer as it means of communicating with the server 2. The Jornada 690 has a keyboard, as well as a touch screen input, and can access the web, etc. using modem, or network cards connected through its PC card slot.

The screen of the Jornada 690 can display colour and has a resolution of 640×240 pixels (i.e. landscape). (It is also possible for the PDA to have a portrait perspective screen).

The PC 30 can have an architecture similar to that shown in FIG. 3, although it could be any other computing device capable of communicating with the server (e.g. an APPLE MAC). Its display is likely to be able to display 24-bit true colour (in excess of 16 million colours) at a resolution of 1024×768.

From the preceding paragraphs it will be appreciated that each of the devices shown in FIG. 4 (the WAP telephone 26, the PDA 28, and the PC 30 ) each have different display properties. Therefore, a document tailored for one of the devices will not necessarily be displayed correctly on the other devices. The problem of displaying documents correctly is a particular concern on the devices with more limited displays such as WAP telephones 26 and PDA's 28, and it is generally less of a problem of PC's 30 that have a larger display.

It will be appreciated that when displayed on a display, for a given font characteristic, i.e. typeface and point size, a particular word will have a fixed length. However, it is possible to change this length by altering the font and character spacing and an example of this is shown in FIG. 5. Further, it is possible to abbreviate words or choose a synonym to achieve additional compression and this is further shown in FIG. 5.

For example rows 1 to 6 of FIG. 5 show examples of the word “micro-meter” displayed in all capital letters in two different typefaces, shown in two different point sizes, with altered spacing between the characters. Rows 7 to 10 of the Figure show the same word displayed in lower case. Again, the word is shown in two different typefaces, and two different point sizes for these typefaces. Rows 11 and 12 give an example of the compression that can be achieved by using a synonym (micron than micro-meter). Rows 13 and 14 give a further example of the compression that can be achieved by using an abbreviation rather than the synonym (μm rather than micron).

It will therefore be apparent that a large number of parameters can be changed in relation to a word displayed on the display to represent the same information and yet greatly reduce the amount of display that is needed for that word.

In one embodiment of the invention the document 24 is written such that it is suitable for display on a PC 30. When the server 2 receives a request for the document 24 it checks the identity of the data-receiving device requesting the document. If the data-receiving device is a PC 30 then the server 2 does not alter the content of the document 24 and delivers it for display on the PC 30.

However, if the data-receiving device is the WAP telephone 26 or the PDA 28 then the server 2 performs further functions. Once the identity of the data-receiving device is known the server 2 checks a database 32 to obtain the screen and font metrics (screen characteristics). This is represented on FIG. 6. It is possible that the data-receiving device sends its identity when making a request for data, or the server 2 could interrogate the data-receiving device to ascertain the device's identity. Indeed, in some embodiments, identity of the data-receiving device is not known, but parameters defining the display of the data-receiving device are instead ascertained.

Once the display characteristics have been ascertained the server 2 ascertains whether or not the document 24 will correctly be displayed on the data-receiving device 26, 28, 30 making the request. If the document 24 will be correctly displayed then it is sent to the device making the request. The more complex the document 24 the more likely it is that it will not be displayed correctly.

If the server 2 determines that the document 24 will not be displayed correctly, then the server consults a second database 34 that contains a range of synonyms and abbreviations or other suitable replacement data. The server 2 then processes 35 the document 24 replacing words with synonyms and abbreviations as well as altering the font sizes and character spacings according to predetermined rules so that the document 24 is displayed correctly 36. The server 2 may determine that the document 24 will not be displayed correctly if words would run off the edge of the display of the data-receiving device, or other similar occurrences. In an alternative, the database may be replaced by a set of rules which determine replacement data from an analysis of the content of the document. Examples of suitable replacement data rules are as follows (the list is not exhaustive):

Example Text Replacement Rules

| Match | Replace With | Kind of Rule |
|---|---|---|
| introduction | intro. | abbreviation |
| depart | go | synonym |
| appointment[s] | date[s] | synonym (with plural |
| | | match) |
| *tion | *t'n | abbreviation (with general |
| | | prefix match) |
| execute program | run | colloquial synonymous |
| | | phrase |
| do not | don't | abbreviated phrase |
| estimated time of arrival | ETA | acronym |
| name of * | *'s name | application with apostrophe |
| | | (with general word match) |
| news of the day | news | removal of redundant |
| | | phrase |

Processing 35 of the document 24 is an iterative process, which begins with the server 2 making a first level of processing. If the first level is not sufficient to allow the document 24 to be displayed correctly a further processing 35 is performed, with further steps until the document is displayable by the data-receiving device making the request for data. For each level of processing 35 the server 2 consults the database of synonyms/abbreviations 34.

In one example the processing strategy may follow the example laid out in FIG. 5, in which row 1 shows the least processing, and row 14 shows the most compression.

In this embodiment the method calculates the effect of applying a level of processing to the data. For example the data may be text held in the format of row 1 FIG. 5. The processing circuitry then calculates the effect changing the formatting to that shown in row 2 (i.e. change the font from Albertville extra bold to times new roman) would have and re-determine whether or not the data now fits on the display of the data-receiving device (i.e. fits the known parameters). If data still does not fit, the processing circuitry assess the effect of reducing the character spacing from the format shown in row 1. This effectively undoes the change of font and considers the effect of changing the formatting to that shown in row 3 of the table, rather than to row 4, which would have been the case if the change of font had not been undone.

In other embodiments the server 2 may transmit the document 24 to a data-receiving device requesting data and assume that the data-receiving device 26, 28, 30 can correctly display it unless it receives an error message from the data-receiving device. For such an embodiment the communication between the data-receiving device 26, 28, 30 and the server 2 is two way as indicated by the double headed arrows in FIGS. 4, 6, and 7.

In this embodiment, if the server 2 receives an error message then it performs processing 35 of the document 24 as described above and retransmits the document 24. This loop is continued until either the document is sent and no error code has been received, or the document 24 has been processed to the full extent possible.

In yet a further embodiment, as represented in FIG. 6 the processing 38 is performed on the data-receiving device 26, 28, 30. The document 24 is held on the server 2 and sent 40 by the server to the data-receiving device when it is requested. The data-receiving device 26, 28, 30 has a screen/font metrics database 42 defining its display characteristics together with a synonym/abbreviation database 44. The data-receiving device receives the transmitted document and processes it in the same iterative manner as described above when the processing was performed on the server 2. The received document is displayed when it can be displayed according to the display characteristics defined in the database 42.

An alternative to the iterative methods used above for determining the most suitable version of content is to use a negotiation protocol such as JetSend (described in EP 0872991). The server 2 may prepare a hierarchy of options for data presentation to the receiving device 26, 28, 30, and receive in return a selection from that hierarchy representing an appropriate choice of content for that receiving device. Such a negotiation will generally lead to provision of the richest content that can be used effectively by the receiving device.

The skilled person will appreciate that the embodiments described herein are examples of how the invention may be performed Certain features have been described in relation to only some of the embodiments described. However, many features could be equally applied to embodiments in relation to which they have not been mentioned.

1. A method of sending data, said data comprising at least one character string held on a primary processing apparatus, capable of receiving a request for data, to at least one data-receiving device on receipt by said primary processing apparatus of a request for data and causing a processing circuitry capable of processing said data to assess said data and perform at least one of the following:
i. access a database of replacement data and replace at least a portion of said at least one character string with replacement data selected from said database;
ii. access a database of replacement data rules and replace at least a portion of said at least one character string with replacement data determined by said replacement data rules;
iii. alter font characteristics of at least one character string in order to tailor said at least one character string to be correctly displayed; and
iv. delete at least a portion of said at least one character string.

2. A method according to claim 1 comprising providing said processing circuitry on said primary processing apparatus.

3. A method according to claim 1 comprising providing said processing circuitry on said data receiving apparatus.

4. A method according to claim 1 comprising providing said data-receiving device with a display capable of displaying said data; and causing said processing circuitry to replace portions of said at least one character string with replacement data having the same or substantially the same meaning as the replaced portions, but which better fit at least a portion of said display of said data-receiving device.

5. A method according to claim 4 wherein said data is text and said replacement data comprises a synonym of said replaced portion.

6. A method according to claim 4 wherein said data is text and said replacement data comprises an abbreviation of said replaced portions.

7. A method according to claim 1 comprising maintaining in said database of replacement data a list of synonyms and abbreviations for at least one item of said data.

8. A method according to claim 1 wherein said data-receiving device comprises a display capable of displaying at least one character string, and wherein said data held on said primary processing apparatus has predetermined characteristics such that when it is displayed it appears in a predetermined manner, said method comprising causing said processing circuitry to alter said predetermined characteristics of said data such that it fits into a predetermined portion of said display of said data-receiving device.

9. A method according to claim 8 wherein said data comprises at least one string of characters and said predetermined characteristics comprise at least one of the following: the font of said characters; the point size of said characters; whether said characters are in upper case; whether said characters are in lower case; the spacing between said characters; whether said characters are bold characters; whether said characters are italic characters; and any other characteristic of said characters that effects the dimension of characters when they are displayed on said display of said data-receiving device.

10. A method according to claim 1 wherein said processing comprises deleting portions of said data which are redundant.

11. A method according to claim 1 wherein said data-receiving device comprises a display capable of displaying said data and has parameteres associated therewith and the method comprises iteratively performing said method, further comprising performing a first level of processing, assessing whether said first level of processing allows said data to meet said known parameters and if not performing further levels of processing until said data meets said known parameters.

12. A method according to claim 1 comprising providing at least a first manner of processing said data and a second manner of processing said data, said method comprising applying said first manner of processing said data and, if said first manner of processing is unsuccessful, undoing said first manner of processing and applying said second manner of processing said data.

13. A method according to claim 1 comprising providing a first manner of processing said data and further manners of processing said data, said method further comprising applying said first manner of processing said data and subsequently applying said at least one of said further manners of processing said data.

14. A method according to claim 1 comprising providing said data-receiving devices with displays and causing said data-receiving devices to display on said displays said data that they are sent by said primary processing apparatus.

15. A method according to claim 1 comprising providing a network connection capable of transmitting data, said method comprising sending data between said primary processing apparatus and said data receiving device via said network connection.

16. A method according to claim 1 wherein said primary processing apparatus is capable of determining the identity of said data-receiving device and of sending data, and said method comprises causing said primary processing apparatus to determine the identity of said data-receiving device before data is sent from said primary processing apparatus.

17. A method according to claim 16 wherein said data-receiving device is capable of sending its identity and said method comprises causing said data-receiving device to send its identity to said primary processing apparatus.

18. A method according to claim 1 wherein said data-receiving device comprises a display and is capable of sending parameters of said display and said primary processing device is capable of receiving said parameters, the method comprising causing said data-receiving device to sent said parameters to said primary processing apparatus.

19. A method of sending data comprising providing a primary processing apparatus capable of receiving a request for data, at least one data-receiving device capable of receiving data and a processing circuitry capable of assessing data by comparison to at least one parameter and of processing data, said method comprising sending data held on said primary processing apparatus to said at least one data-receiving device on receipt by said primary processing apparatus of a request for data, said method further comprising causing said processing circuitry to compare said data with said at least one parameter and process said data such that it meets at least one of said at least one parameters and including the step of sending the data to the data-receiving device.

20. A computer readable medium holding instructions arranged to cause a computer to perform the method of claim 1 when loaded thereonto.

21. A computer readable medium holding instructions arranged to cause a computer to perform the method of claim 19 when loaded thereonto.

22. A processing apparatus arranged to hold data and comprising processing circuitry capable of processing data, said processing circuitry including a transmitter and a receiver, said receiver being capable of receiving a data request, and said transmitter being capable of transmitting data, said processing circuitry being arranged to process said data on receipt of said request in accordance with the method of claim 19 and said transmitter being arranged to transmit said processed data.

23. A data-receiving device capable of being controlled by software, wherein the software is tailored to facilitate communication with said processing apparatus of claim 22.

24. A device according to claim 22 that is arranged to communicate its identity to said processing apparatus.

25. A device according to claim 22 comprising a display and that is arranged to communicate to said processing apparatus the characteristics of said display.

26. A method of sending data, said data comprising at least one character string held on a primary processing apparatus, capable of receiving a request for data, to at least one data-receiving device, said data-receiving device comprising a display which is capable of displaying said data said method comprising sending data on receipt by said primary processing apparatus of a request for data and causing a processing circuitry capable of processing said data to assess said data and perform at least one of the following:
i. access a database of replacement data and replace at least a portion of said at least one character string with replacement data selected from said database, said replacement data having substantially the same meaning as said replaced portions, but which better fits at least a portion of said display of said data-receiving device;
ii. access a database of replacement data rules and replace at least a portion of said at least one character string with replacement data determined by said replacement data rules, said replacement data having substantially the same meaning as said replaced portions, but which better fits at least a portion of said display of said data-receiving device;
iii. altering font characteristics in order to tailor said at least one character string to better fit at least a portion of said display of said data-receiving device; and
iv. deleting a portion of said at least one character string.

27. A method of sending data, said data comprising at least one character string held on a primary processing apparatus, capable of receiving a request for data, to at least one data-receiving device, said data-receiving device comprising a display which is capable of displaying said data, said method comprising sending data on receipt by said primary processing apparatus of a request for data and causing a processing circuitry capable of processing said data to assess said data and perform at least one of the following:
i. access a database of replacement data and replace at least a portion of said at least one character string with replacement data selected from said database, said replacement data having substantially the same meaning as said replaced portions, but which better fits at least a portion of said display of said data-receiving device;
ii. access a database of replacement data rules and replace at least a portion of said at least one character strings with replacement data determined by said replacement data rules, said replacement data having substantially the same meaning as said replaced portions, but which better fits at least a portion of said display of said data-receiving device;
iii. deleting a portion of said at least one character string.

28. A method of sending data, said data comprising at least one character string held on a primary processing means, capable of receiving a request for data, to at least one data-receiving means on receipt by said primary processing means of a request for data and causing a processing circuitry capable of processing said data to assess said data and perform at least one of the following:
i. access a database means containing replacement data and replace at least a portion of said at least one character string with replacement data selected from said database means;
ii. access a database means containing replacement data rules and replace at least a portion of said at least one characterising with replacement data determined by said replacement data rules;
iii. alter font characteristics in order to tailor said at least one character string to be correctly displayed; and
iv. delete at least a portion of said at least one character string.

29. A processing apparatus arranged to hold data and comprising processing circuitry and a transmitter and receiver, said receiver arranged to receive a data request and pass said request to said processing circuitry, on receipt of said data request said processing circuitry being arranged to process said data to determine whether it is configured for transmission and said transmitter being arranged to transmit said processed data wherein said processing circuitry is arranged to perform one or more of the following:
i. replace a portion of said data with data selected from a database of replacement data or determine by a database of replacement data rules;
ii. altering font characteristics of said data; and
iii. deleting at least a portion of said data.
